(19) United States
(12) Patent Application Publication
(10) Pub. No.: US 2023/0200513 A1
(43) Pub. Date: Jun. 29, 2023

(54) Gel Nail UV Curing Light and Applicator Device

(71) Applicant: Sonny Truong Lam, Morganton, NC (US)

(72) Inventor: Sonny Truong Lam, Morganton, NC (US)

(21) Appl. No.: 17/673,411

(22) Filed: Feb. 16, 2022

Related U.S. Application Data
(60) Provisional application No. 63/294,215, filed on Dec. 28, 2021.

(51) Int. Cl. A45D 29/00

(52) U.S. Cl. CPC A45D 29/00; A45D 2200/205

(57) ABSTRACT

The present invention relates to a gel nail UV curing light and applicator device that is primarily comprised of a body with a first end that has at least one bulb, a bulb cover, and a cap, and a second end further comprised of at least one button. The bulb of the device is preferably a UV light. The bulb cover can be placed over the bulb such that a nail accessory can be placed on the top surface of the bulb cover. The device can then be pressed against the top surface of a nail that has been coated with a gel product. Therefore, the nail accessory is pressed into the nail via the device and is also simultaneously cured to the gel product via the UV light.

### CROSS-REFERENCE TO RELATED APPLICATION

The present application claims priority to, and the benefit of, U.S. Provisional Application No. 63/294,215, which was filed on Dec. 28, 2021, and is incorporated herein by reference in its entirety.

### FIELD OF THE INVENTION

The present invention relates generally to the field of nail devices. More specifically, the present invention relates to a gel nail UV curing light and applicator device that is primarily comprised of a body with a first end that has at least one bulb, a bulb cover and a cap, and a second end further comprised of at least one button. The bulb of the device is preferably a UV light. The bulb cover can be placed over the bulb such that a nail accessory can be placed on the top surface of the bulb cover. The device can then be pressed against the top surface of a nail that has been coated with a gel product. Therefore, the nail accessory is pressed into the nail via the device and is also simultaneously cured to the gel product via the UV light. Accordingly, the present disclosure makes specific reference thereto. Nonetheless, it is to be appreciated that aspects of the present invention are also equally applicable to other like applications, devices and methods of manufacture.

### BACKGROUND

Gel-based nails are regularly used within the nail industry. However, gel nails must be cured with an ultra-violet (UV) light. During the application process of gel nails, some gel polish may shrink around the edge of the nail, which gives the effect that nail is not fully covered with polish. Further, some brands of gel polish are runny, such that they spill over from the nail and onto the surrounding skin of the finger when the nails are moved under a curing light. In addition, various nail accessories such as sequins, charms, stickers, decals, etc. are often placed on gel nails. However, these accessories must be pressed onto the nail and held down for a period of time until cured to the nail.

Therefore, there exists a long-felt need in the art for a device that improves the process of applying gel nails. There also exists a long-felt need in the art for a gel nail UV curing light and applicator device that does not require a user to move his or her nails under a curing light, therefore eliminating the possibility of gel polish running as a result of hand movement. In addition, there exists a long-felt need in the art for a gel nail UV curing light and applicator device that offers an improved means to apply and cure nail accessories.

The subject matter disclosed and claimed herein, in one embodiment thereof, comprises a gel nail UV curing light and applicator device. The device is primarily comprised of a body with a first end that has at least one bulb, a bulb cover and a cap, and a second end further comprised of at least one button. The bulb of the device is preferably a UV light. The bulb cover can be placed over the bulb such that a nail accessory can be placed on the top surface of the bulb cover. The device can then be pressed against the top surface of a nail that has been coated with a gel product. Therefore, the nail accessory is pressed into the nail via the device and is also simultaneously cured to the gel product via the UV light.

In this manner, the gel nail UV curing light and applicator device of the present invention accomplishes all of the forgoing objectives and provides a device that improves the process of applying gel nails which does not require a user to move his or her nails under a curing light. As a result, the possibility of gel polish running as a result of hand movement is eliminated. Further, the device offers an improved means to apply and cure nail accessories.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a gel nail UV curing light and applicator device. The device is primarily comprised of a body with a first end that has at least one bulb, a bulb cover and a cap, and a second end further comprised of at least one button. In the preferred embodiment of the device, the body is manufactured from a durable metal or a rigid plastic The body is further preferably cylindrical in shape, but may be any shape known in the art such as, but not limited to, square, round, triangular, rectangular, etc. in differing embodiments. The outer surface of the body may further be textured or have at least one textured grip area that features knurling, protrusions or other grip texture of the like that encourages grip and prevents slippage while the device is being held.

The first end of the body is further comprised of at least one bulb, wherein the bulb is preferably an ultraviolet (UV) bulb. However, the bulb may be any bulb type known in the art that allows a gel nail polish, gel nail compound or other nail compound of the like to be cured by the light emitted by the bulb. The first end further has a raised lip which receives a bulb cover (i.e., wherein the diameter of the bulb cover is smaller than the diameter of the first end such that the bulb cover sits within the first end). The cover is preferably manufactured from a transparent, silicone material, but may also be manufactured from a transparent glass or plastic material.

The bulb cover can be removed from the bulb when not in use, or can be secured to the body and covered by a cap that is preferably manufactured from a rigid material such as, but not limited to, plastic, metal, etc. The cap can be placed over the bulb cover and snap onto (and contact) the outer surface of the body. In this manner, the bulb cover is protected by the cap when the device is not in use.

The second end (and/or any portion of the body) is further comprised of at least one button that may allow the user to turn the bulb on/off, change the intensity/brightness of the bulb, change the amount of bulbs that illuminate, change the sequence of illumination of the bulbs (i.e., flashing), etc. In addition, the device is comprised of a battery. The battery can be charged or receive power from a charging cable.

To use the device, a user first removes the cap and places the bulb cover over the bulb, if not already in said position. Then, the button can be pressed to power on the bulb and a nail accessory such as, but not limited to: sequins, charms, stickers, decals, etc. can be placed on the top surface of the bulb cover. The top surface of the bulb cover can then be pressed against/rolled onto the top surface of a fingernail that has been coated with a gel nail polish or other similar compound. Then, the nail accessory can be held onto the top surface as the UV bulb cures the accessory to the top surface for as long as necessary. In this manner, a user can simultaneously apply and cure a nail accessory to a fingernail.

Accordingly, the gel nail UV curing light and applicator device of the present invention is particularly advantageous as it improves the process of applying gel nails which does not require a user to move his or her nails under a curing light. As a result, the possibility of gel polish running as a result of hand movement is eliminated. In addition, the device offers an improved means to apply and cure nail accessories. In this manner, the gel nail UV curing light and applicator device overcome the limitations of existing methods of applying and curing gel nails known in the art.

To the accomplishment of the foregoing and related ends, certain illustrative aspects of the disclosed innovation are described herein in connection with the following description and the annexed drawings. These aspects are indicative, however of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a gel nail UV curing light and applicator device of the present invention in accordance with the disclosed architecture;

FIG. 2 illustrates a top view of one potential embodiment of a gel nail UV curing light and applicator device of the present invention in accordance with the disclosed architecture; and

FIG. 3 illustrates an enhanced perspective view of one potential embodiment of a gel nail UV curing light and applicator device of the present invention being used in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that improves the process of applying gel nails. There also exists a long-felt need in the art for a gel nail UV curing light and applicator device that does not require a user to move his or her nails under a curing light, therefore eliminating the possibility of gel polish running as a result of hand movement. In addition, there exists a long-felt need in the art for a gel nail UV curing light and applicator device which offers an improved means to apply and cure nail accessories.

The present invention, in one exemplary embodiment, is comprised of a gel nail UV curing light and applicator device. The device is primarily comprised of a body with a first end that has at least one bulb, a bulb cover and a cap, and a second end further comprised of at least one button. The bulb of the device is preferably a UV light, wherein a bulb cover can be placed over the bulb. A nail accessory can further be placed on the top surface of the bulb cover. As a result, the device can then be pressed against the top surface of a nail that has been coated with a gel product. Therefore, the nail accessory is pressed into the nail via the device and is also simultaneously cured to the gel product via the UV light.

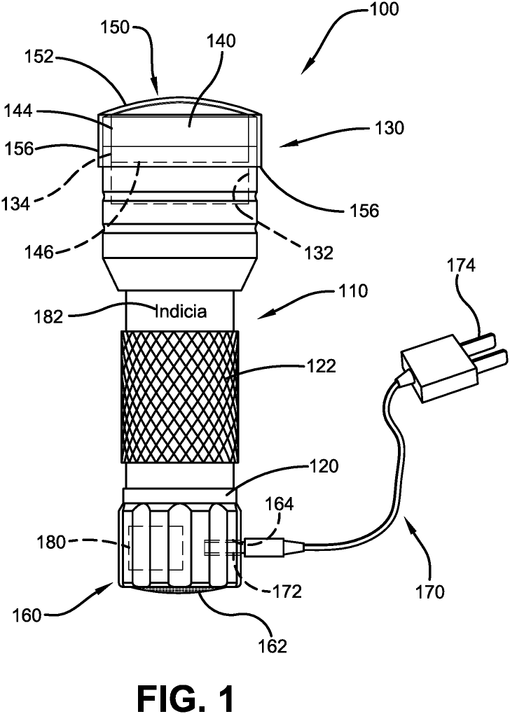

Referring initially to the drawings, FIG. 1 illustrates a perspective view of one potential embodiment of a gel nail UV curing light and applicator device 100 of the present invention in accordance with the disclosed architecture. The device 100 is primarily comprised of a body 110 with a first end 130 that has at least one bulb 132, a bulb cover 140 and a cap 150, and a second end 160 further comprised of at least one button 162. In the preferred embodiment of the device 100, the body 110 is manufactured from a durable metal such as, but not limited to, stainless steel or aluminum. The body 110 may also be manufactured from a rigid plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. In differing embodiments, the body 110 may further be any color in the art and may be transparent, semi-transparent or opaque. The body 110 is further preferably cylindrical in shape, but may be any shape known in the art such as, but not limited to, square, round, triangular, rectangular, etc., in differing embodiments.

The outer surface 120 of the body 110 can also have a plurality of indicia 182 such as, but not limited to, patterns, logos, emblems, images, symbols, designs, letters, numbers, words, characters, animals, advertisements, brands, etc. The outer surface 120 may further be textured or have at least one textured grip area 122 that features knurling, protrusions or other grip texture of the like that accourages grip and prevents slippage while the device 100 is being held.

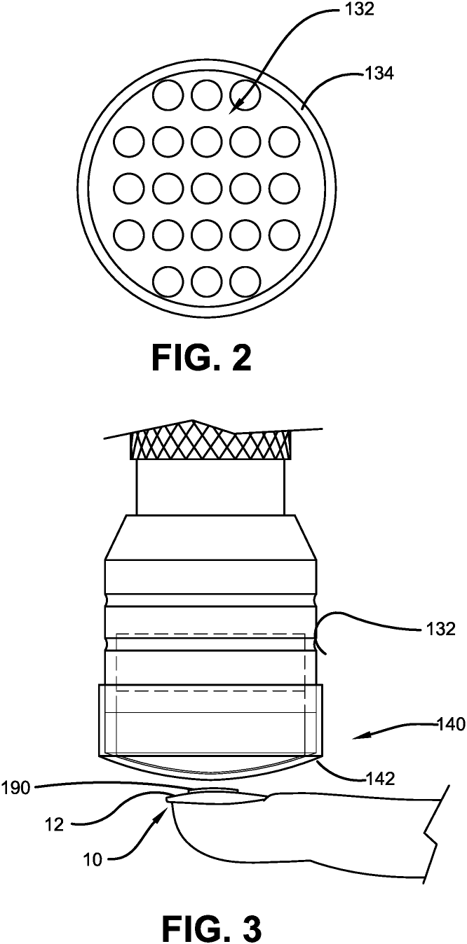

FIG. 2 illustrates a top view of one potential embodiment of a gel nail UV curing light and applicator device 100 of the present invention in accordance with the disclosed architecture. The first end 130 of the body 110 is further comprised of at least one bulb 132, wherein the bulb 132 may be removable (i.e., replaceable) or fixedly attached to the body 110 in differing embodiments. The bulb 132 is preferably an ultraviolet (UV) bulb but may be any bulb type known in the art that allows a gel nail polish, gel nail compound or other nail compound of the like to be cured by the light emitted by the bulb 132. The first end 130 further has a raised lip 134 which receives a bulb cover 140 (i.e., the diameter of the bulb cover 140 is smaller than the diameter of the first end 130 such that the bulb cover 140 sits within the first end 130). The cover 140 is preferably manufactured from a transparent, silicone material, but may also be manufactured from a transparent glass or plastic material. The cover 140 further has a convex top surface 142, a side surface 144 that sits within the lip 134 and a flat or convex bottom surface 146.

The bulb cover 140 can be removed from the bulb 132 when not in use, or can be secured to the body 110 and covered by a cap 150. The cap 150 is preferably manufactured from a rigid material such as, but not limited to, plastic, metal, etc. The cap 150 further preferably has a convex top surface 152, a side surface 154 and a bottom surface in the form of a continuous opening 156. In this manner, the cap 150 can be placed over the bulb cover 140 and snap onto (and contact) the outer surface 120 of the body 110. In this manner, the bulb cover 140 is protected by the cap 150 when the device 100 is not in use.

The second end 160 (and/or any portion of the body 110) is further comprised of at least one button 162. The button 162 may allow the user to turn the bulb 132 on/off, change the intensity/brightness of the bulb 132, change the amount of bulbs 132 that illuminate, change the sequence of illumination of the bulbs 132 (i.e., flashing), etc. The button 162 may further only need to be pressed/depressed once, or can have a momentary on/off feature that requires constant pressure.

The device 100 is further comprised of a battery 180. The battery 180 may be a disposable battery 180 or a rechargeable battery 180 in the form of an alkaline, nickel-cadmium, nickel-metal hydride battery 180, etc. such as any 3 V-12 volts DC battery 180 or other conventional battery 180 such as A, AA, AAA, etc. that supply power to the device 100. Throughout this specification the terms “battery” and “batteries” may be used interchangeably to refer to one or more wet or dry cells or batteries 180 of cells in which chemical energy is converted into electricity and used as a source of DC power. References to recharging or replacing batteries 170 may refer to recharging or replacing individual cells, individual batteries 180 of cells, or a package of multiple battery cells as is appropriate for any given battery 180 technology that may be used. Additionally, the battery 180 may be recharged by a female charging port 164. The charging port 164 may be a female USB port such as, but not limited to, USB-A, USB-B, Micro-B, Micro-USB, Mini-USB, USB-C, etc. In a differing embodiment, the female charging port 164 may be a female 9 V or 12 V port. In differing embodiments, the device 100 may further be powered by a plurality of differing amperage draws.

The device 100 is also comprised of at least one charging cable 170. The cable 170 has at least one male charging port 172 that may be of the USB or 9 V/12 V type as described above. The cable 170 may further a second male charging port 172 of the same type, or may have at least one male plug 174 that can be plugged into a traditional 110 V/240 V outlet. In one embodiment, the device 100 requires and receives constant power from the cable 170. In a differing embodiment, the battery 180 can be charged by the cable 170 and used without the cable 170.

FIG. 3 illustrates an enhanced perspective view of one potential embodiment of a gel nail UV curing light and applicator device 100 of the present invention being used in accordance with the disclosed architecture. To use the device 100, a user first removes the cap 150. Then, the bulb cover 140 can be placed over the bulb 132, if not already in said position. Then, the button 162 can be pressed to power on the bulb 132. Next, a nail accessory 190 such as, but not limited to, sequins, charms, stickers, decals, etc., can be placed on the top surface 142 of the bulb cover 140. The top surface 142 can then be pressed against/rolled onto the top surface 12 of a fingernail 10 that has been coated with a gel nail polish or other similar compound. Then, the nail accessory 190 can be held onto the top surface 12 as the UV bulb 132 cures the accessory 190 to the top surface 12 for as long as necessary. In this manner, a user can simultaneously apply and cure a nail accessory 190 to a fingernail 10.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “gel nail UV curing light and applicator device” and “device” are interchangeable and refer to the gel nail UV curing light and applicator device 100 of the present invention.

Notwithstanding the forgoing, the gel nail UV curing light and applicator device 100 of the present invention and its various components can be of any suitable size and configuration as is known in the art without affecting the overall concept of the invention, provided that they accomplish the above-stated objectives. One of ordinary skill in the art will appreciate that the size, configuration and material of the gel nail UV curing light and applicator device 100 as shown in the FIGS. are for illustrative purposes only, and that many other sizes and shapes of the gel nail UV curing light and applicator device 100 are well within the scope of the present disclosure. Although the dimensions of the gel nail UV curing light and applicator device 100 are important design parameters for user convenience, the gel nail UV curing light and applicator device 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gel nail UV curing light and applicator device comprising:
a body having an outer surface with a grip area;
a bulb;
a bulb cover that can be placed over the bulb;
a cap that can be placed over the bulb cover;
a button for activating the bulb;
a battery that powers the bulb; and
a charging cable that powers the battery.

2. The gel nail UV curing light and applicator device of claim 1, wherein the bulb is an ultraviolet bulb.

3. The gel nail UV curing light and applicator device of claim 1, wherein the bulb cover is comprised of a convex top surface.

4. The gel nail UV curing light and applicator device of claim 3, wherein the bulb cover is comprised of a transparent material.

5. A gel nail UV curing light and applicator device comprising:
a body having an outer surface with a grip area;
an ultraviolet bulb;
a transparent bulb cover that is positioned over the ultraviolet bulb;
a cap that is positioned over the bulb cover;
a button;
a female charging port;
a battery that powers the ultraviolet bulb; and
a charging cable for charging the battery.

6. The gel nail UV curing light and applicator device of claim 5, wherein the bulb cover is manufactured from a glass, a silicone or a plastic material.

7. The gel nail UV curing light and applicator device of claim 5, wherein the button turns the ultraviolet bulb on or off, changes the intensity or brightness of the ultraviolet bulb and changes a sequence of illumination of the ultraviolet bulb.

8. The gel nail UV curing light and applicator device of claim 5, wherein the female charging port is a USB charging port, a 9 V charging port or a 12 V charging port.

9. The gel nail UV curing light and applicator device of claim 5, wherein the charging cable is comprised of a male USB charging port, a male 9 V charging port or a male 12 V charging port.

10. The gel nail UV curing light and applicator device of claim 5, wherein the gel nail UV curing light and applicator requires constant power from the charging cable.

11. The gel nail UV curing light and applicator device of claim 5, wherein the cap snaps onto the outer surface of the body.

12. The gel nail UV curing light and applicator device of claim 11, wherein the cap protects the transparent bulb cover when the gel nail UV curing light and applicator device is not in use.

13. A gel nail UV curing light and applicator device comprising:
a body comprised of an outer surface with a grip area and a first end having a lip;
a plurality of ultraviolet bulbs that fit within the lip of the first end of the body;
a transparent bulb cover that can be placed over each of the plurality of ultraviolet bulbs, wherein the transparent bulb cover has a convex top surface;
a cap that can be placed over the transparent bulb cover;
a button;
a female charging port;
a battery that powers the plurality of ultraviolet bulbs; and
a charging cable for charging the battery.

14. The gel nail UV curing light and applicator device of claim 13, wherein the transparent bulb cover is manufactured from a glass, a silicone or a plastic material.

15. The gel nail UV curing light and applicator device of claim 13, wherein the button turns the plurality of ultraviolet light bulbs on or off, changes the intensity or brightness of the plurality of ultraviolet light bulbs, changes a number of the plurality of ultraviolet light bulbs that are illuminated at one time, and changes a sequence of illumination of the plurality of ultraviolet light bulbs.

16. The gel nail UV curing light and applicator device of claim 13, wherein the female charging port is a USB charging port, a 9 V charging port or a 12 V charging port.

17. The gel nail UV curing light and applicator device of claim 13, wherein the charging cable is comprised of a male USB charging port, a male 9V charging port or a male 12V charging port.

18. The gel nail UV curing light and applicator device of claim 13, wherein the gel nail UV curing light and applicator requires constant power from the charging cable.

19. The gel nail UV curing light and applicator device of claim 13, wherein the cap snaps onto the outer surface of the body.

20. The gel nail UV curing light and applicator device of claim 19, wherein the cap protects the transparent bulb cover when the gel nail UV curing light and applicator device is not in use.
